(19) United States
(12) Patent Application Publication
(10) Pub. No.: US 2016/0002572 A1
(43) Pub. Date: Jan. 7, 2016

(54) USE OF ALKOXYLATED POLYPROPYLENIMINE FOR LAUNDRY CARE AND COMPOSITIONS THEREFORE

(71) Applicant: BASF SE, Ludwigshafen (DE)

(72) Inventors: Sophia EBERT, Mannheim (DE); Bjoern LUDOLPH, Ludwigshafen (DE); Christoph MUELLER, Mannheim (DE); Stephan HUEFFER, Ludwigshafen (DE); Alejandra GARCIA MARCOS, Ludwigshafen (DE)

(73) Assignee: BASF SE, Ludwigshafen (DE)

(21) Appl. No.: 14/766,901

(22) PCT Filed: Feb. 24, 2014
(86) PCT No.: PCT/EP2014/053488

§ 371 Date: Aug. 10, 2015

Related U.S. Application Data
(60) Provisional application No. 61/770,342, filed on Feb. 28, 2013.

(30) Foreign Application Priority Data
Feb. 28, 2013 (EP) 13157177.0

(51) Int. Cl. C11D 3/37; C11D 3/20; C11D 3/00; C11D 1/22; C11D 1/12

(52) U.S. Cl. CPC C11D 3/3723; C11D 3/3788; C11D 1/22; C11D 1/12; C11D 3/0036; C11D 3/2086

(57) ABSTRACT

Use of alkoxylated polypropylenimine for laundry care and compositions therefore Use of alkoxylated polypropylenimines (A) for laundry care.

The present invention is directed towards the use of alkoxylated polypropylenimines (A) for laundry care. Furthermore, the present invention is directed towards detergent compositions comprising at least one alkoxylated polypropylenimine (A) and to a process for making detergent compositions.

Compositions for laundry care are still the field of developmental and research work. Improvement of the efficiency of current compositions is still of interest, since either more laundry can be cleaned with the same amount of composition, or less active matter needs to be used, or more soil can be removed, and the environment can be spared sewage water with a higher amount of surfactant.

The use of highly branched alkoxylated polyethylenimine as ingredient for laundry care compositions is known, see, for example, US 2011/0036374. However, the efficiency in particular for degreasing applications of the compositions disclosed still leave room for improvement. Additionally, it has been found that polyethylene imines may have disadvantageous properties with respect to clay soil removal/anti-redeposition applications, see WO 2012/156260.

It was therefore an objective to provide a solution to the problems indicated above. Furthermore, it was an objective to provide compositions with improved laundry care properties. It was further an objective to provide a method for making compositions with improved laundry care properties, in particular with improved laundry cleaning properties.

Accordingly, the use defined in the outset has been found. The use according to the invention is directed towards the use of one alkoxylated polypropylenimines (A) selected from those with a polypropylenimine backbone with a molecular weight Mₙ in the range of from 300 to 4,000 g/mol, also being referred to as alkoxylated polypropylenimine (A) or alkoxylate (A), in laundry care, in particular for laundry cleaning. A related aspect is a method of use of alkoxylated polypropylenimines (A) for laundry care, and in particular a process for treating laundry by applying at least one alkoxylated polypropylenimines (A).

Alkoxylated polypropylenimine (A) will be described in more detail below.

Alkoxylated polypropylenimine (A) comprises alkoxy side chains and a backbone of polypropylenimine. The polypropylenimine backbone can be linear, predominantly linear or branched, predominantly linear being preferred and linear being more preferred. The structure of the polypropylenimine backbone is depending on the type of synthesis of the respective polypropylenimine. In the context of the present invention, said polypropylenimine can also be referred to as “backbone”, as “backbone of alkoxylate (A)” or as “backbone of alkoxylated polyproplylenimine (A)”.

Polypropylenimines as defined in the context with the present invention can also be regarded as polypropylenepolyamines. They bear at least 6 N-atoms per molecule in the form of amino groups, e. g., as NH₂-groups, as secondary amino groups or as tertiary amino groups. The term “polypropylenimine” in the context of the present invention does not only refer to polypropylenimine homopolymers but also to polyalkylenimines containing NH—CH₂—CH₂—CH₂—NH structural elements or NH—CH₂—CH(CH₃)—NH structural elements together with other alkylene diamine structural elements, for example NH—CH₂—CH₂—NH structural elements, NH—(CH₂)₄—NH structural elements, NH—(CH₂)₆—NH structural elements or (NH—(CH₂)₈—NH structural elements but the NH—CH₂—CH₂—CH₂—NH structural elements or NH—CH₂—CH(CH₃)—NH structural elements being in the majority with respect to the molar share. Preferred polypropylenimines contain NH—CH₂—CH₂—CH₂—NH structural elements being in the majority with respect to the molar share, for example amounting to 60 mol-% or more, more preferably amounting to at least 70 mol-%, referring to all alkylenimine structural elements. In a special embodiment, polypropylenimine refers to those polyalkylene imines that bear one or zero alkylenimine structural element per molecule that is different from NH—CH₂—CH₂—CH₂—NH.

Branches may be alkylenamino groups such as, but not limited to —CH₂—CH₂—NH₂ groups or (CH₂)₃—NH₂-groups. Longer branches may be, for examples, —(CH₂)₃—N(CH₂CH₂CH₂NH₂)₂ groups. Highly branched polypropylenimines are, e.g., polypropylene dendrimers or related molecules with a degree of branching in the range from 0.25 to 0.95, preferably in the range from 0.30 to 0.80 and particularly preferably at least 0.5. The degree of branching can be determined for example by ¹³C-NMR spectroscopy, preferably in D₂O, or by ¹⁵N-NMR spectroscopy, and is defined as follows:

DB=D+T/D+T+L

with D (dendritic) corresponding to the fraction of tertiary amino groups, L (linear) corresponding to the fraction of secondary amino groups and T (terminal) corresponding to the fraction of primary amino groups.

Within the context of the present invention, highly branched polypropylenimines are polypropylenimines with DB in the range from 0.25 to 0.95, particularly preferably in the range from 0.30 to 0.90 and very particularly preferably at least 0.5.

In the context of the present invention, CH₃-groups are not being considered as branches.

Preferred polypropylenimine backbones are those that exhibit little or no branching, thus predominantly linear or linear polypropylenimine backbones.

In certain embodiments of the present invention, the polypropylenimine backbone of alkoxylated polypropylenimine (A) may be obtained by a catalytic polycondensation of propanolamine and, optionally, at least one further amino alcohol, by a catalytic poly-co-condensation of propandiol with propandiamine and, optionally, at least one further diol and/or at least one further diamine, and preferably of a catalytic polycondensation of propandiamine and, optionally, at least one further diamine, the latter polycondensation also being referred to as poly-transamination. Said further amino alcohol, said further diamine and said further diol, respectively, are selected from aliphatic amino alcohols, aliphatic diols and aliphatic diamines.

Examples of aminopropanols are 3-aminopropan-1-ol and 2-aminopropan-1-ol and mixtures thereof, 3-aminopropan-1-ol being preferred.

Optionally, up to 40 mol-% of aminopropanol may be replaced by one or more aminoalcohols other than aminopropanol and bearing at least one primary or secondary amino group and at least one OH group, in particular up to 30 mol-%.

Examples of further amino alcohols are linear or branched alkanolamines such as monoethanolamine, diethanolamine, aminopropanol, for example 3-aminopropan-1-ol or 2-aminopropan-1-ol, aminobutanol, for example 4-aminobutan-1-ol, 2-aminobutan-1-ol or 3-aminobutan-1-ol, aminopentanol, for example 5-aminopentan-1-ol or 1-aminopentan-2-ol, aminodimethylpentanol, for example 5-amino-2,2-dimethylpentanol, aminohexanol, for example 2-aminohexan-1-ol or 6-aminohexan-1-ol, aminoheptanol, for example 2-aminoheptan-1-ol or 7-aminoheptan-1-ol, aminooctanol, for example 2-aminooctan-1-ol or 8-aminooctan-1-ol, aminononanol, for example 2-aminononan-1-ol or 9-aminononan-1-ol, aminodecanol, for example 2-aminodecan-1-ol or 10-aminodecan-1-ol, aminoundecanol, for example 2-aminoundecan-1-ol or 11-aminoundecan-1-ol, aminododecanol, for example 2-aminododecan-1-ol or 12-aminododecan-1-ol, aminotridecanol, for example 2-aminotridecan-1-ol, wherein the respective ω-amino-α-alcohols are preferred over their 1,2-isomers, 2-(2-aminoethoxyl)ethanol, alkylalkanolamines, for example N-n-butylethanolamine, N-n-propylethanolamine, N-ethylethanolamine, and N-methylethanolamine. Preference is given to monoethanolamine.

In a particular embodiment, the backbone of alkoxylated polypropylenimine (A) may be obtained by a catalytic polycondensation of 3-aminopropan-1-ol, without any additional aminoalcohol other than 3-aminopropan-1-ol.

Examples of propandiamines and propanediols diols to be poly-co-condensed for making the polypropylenimine backbone are being described below. The terms propandiamine and propylene diamine are being used interchangeably in the context of the present invention. Examples of propandiamines are propane-1,2-diamine and propane-1,3-diamine and mixtures thereof, propane-1,3-diamine being preferred. Examples of the respective propanediols are 1,2-propylene glycol and 1,3-propylene glycol and mixtures thereof, 1,3-propylene glycol being preferred. Particularly preferred are poly-co-condensations of 1,3-propylene glycol with propane-1,3-diamine.

Optionally, up to 40 mol-% of the sum of propandiamines and propanediols may be replaced by a one or more aliphatic diols other than propanediol and/or one or more aliphatic diamine other than propandiamine, in particular up to 30 mol-%.

Examples of further aliphatic diols are linear or branched aliphatic diols. Special examples of aliphatic diols are ethylene glycol, 2-methyl-1,3-propanediol, butanediols, for example 1,4-butylene glycol or butane-2,3-diol or 1,2-butylene gylcol, pentanediols, for example neopentyl glycol or 1,5-pentanediol or 1,2-pentanediol, hexanediols, for example 1,6-hexanediol or 1,2-hexanediol, heptanediols, for example 1,7-heptanediol or 1,2-heptanediol, octanediols, for example 1,8-octanediol or 1,2-octanediol, nonanediols, for example 1,9-nonanediol or 1,2-nonanediol, decanediols, for example 1,10-decanediol or 1,2-decanediol, undecanediols, for example 1,11-undecanediol or 1,2-undecanediol, dodecanediols, for example 1,12-dodecanediol, 1,2-dodecanediol, tridecanediols, for example 1,13-tridecanediol or 1,2-tridecanediol, tetradecanediols, for example 1,14-tetradecanediol or 1,2-tetradecanediol, pentadecanediols, for example 1,15-pentadecanediol or 1,2-pentadecanediol, hexadecanediols, for example 1,16-hexadecanediol or 1,2-hexadecanediol, heptadecanediols, for example 1,17-heptadecanediol or 1,2-heptadecanediol, octadecanediols, for example 1,18-octadecanediol or 1,2-octadecanediol, wherein the respective α,ω-diols are preferred over their 1,2-isomers 3,4-dimethyl-2,5-hexanediol, diethanolamines, for example butyldiethanolamine or methyldiethanolamine, and other dialcoholamines. Preference is given to ethylene glycol.

Examples of further aliphatic diamines are linear, branched or cyclic diamines. Special examples are ethylenediamine, butylenediamine, for example 1,4-butylenediamine or 1,2-butylenediamine, diaminopentane, for example 1,5-diaminopentane or 1,2-diaminopentane, diaminohexane, for example 1,6-diaminohexane or 1,5-diamino-2-methylpentane or 1,2-diaminohexane, diaminoheptane, for example 1,7-diaminoheptane or 1,2-diaminoheptane, diaminooctane, for example 1,8-diaminooctane or 1,2-diaminooctane, diaminononane, for example 1,9-diaminononane or 1,2-diaminononane, diaminodecane, for example 1,10-diaminodecane or 1,2-diaminodecane, diaminoundecane, for example 1,11-diaminoundecane or 1,2-diaminoundecane, diaminododecane, for example 1,12-diaminododecane or 1,2-diaminododecane, wherein the respective α,ω-diamines are preferred over their 1,2-isomers, 2,2-dimethylpropane-1,3-diamine, 4,7,10-trioxatridecane-1,13-diamine, 4,9-dioxadodecane-1,12-diamine, and 3-(methylamino)propylamine. Preference is given to 1,2-ethylendiamine and 1,4-butandiamine.

In the context of the present invention, also compounds with 2 NH₂-groups and a tertiary amino group, such as, but not limited to N,N-bis(3-aminopropyl)methylamine, are being considered as diamines.

In a particular embodiment, the backbone of alkoxylated polypropylenimine (A) may be obtained by a catalytic poly-co-condensation of 1,3-propylene glycol with propane-1,3-diamine, without any additional diol or diamine other than 1,3-propylene glycol and propane-1,3-diamine, respectively.

The types of polycondensation or poly-co-condensation described above can be carried out in the presence of hydrogen, for example under a hydrogen pressure of from 1 to 10 MPa.

The types of polycondensation or poly-co-condensation described above can be carried out at a temperature in the range of from 20 to 250° C. Preferably, the temperature is at least 100° C. and preferably at most 200° C.

During the polycondensation or poly-co-condensation described above, the water formed can be removed, for example by distilling it off.

Catalysts suitable for the polycondensation or poly-co-condensation described above may preferably be homogeneous. Preferred examples of homogeneous catalysts for the polycondensation or poly-co-condensation described above are transition metal complexes that comprise one or more different transition metals, preferably at least one element from groups 8, 9 and 10 of the Periodic Table of the Elements, particularly preferably ruthenium or iridium. The specified transition metals are present in the form of transition metal complex compounds. Suitable ligands present in transition metal complex compounds suitable as catalysts are, for example, phosphines substituted with alkyl or aryl, polydentate phosphines substituted with alkyl or aryl which are bridged via arylene or alkylene groups, nitrogen-heterocyclic carbenes, cyclopentanedienyl and pentamethylcyclopentadienyl, aryl, olefin ligands, hydride, halide, carboxylate, alkoxylate, carbonyl, hydroxide, trialkylamine, dialkylamine, monoalkylamine, nitrogen aromatics such as pyridine or pyrrolidine and polydentate amines. The transition metal complex compounds can comprise one or more different ligands specified above.

Particularly suitable monodentate phosphine ligands are triphenylphosphine, tritolylphosphine, tri-n-butylphosphine, tri-n-octylphosphine, trimethylphosphine and triethylphosphine, and also di(1-adamantyI)-n-butylphosphine, di(1-adamantyl)benzylphosphine, 2-(dicyclohexylphosphino)-1-phenyl-1H-pyrrole, 2-(dicyclohexylphosphino)-1-(2,4,6-trimethylphenyl)-1H-imidazole, 2-(dicyclohexylphosphino)-1-phenylindole, 2-(di-tert-butylphosphino)-1-phenylindole, 2-(dicyclohexylphosphino)-1-(2-methoxyphenyl)-1H-pyrrole, 2-(di-tert-butylphosphino)-1-(2-methoxyphenyl)-1H-pyrrole and 2-(di-tert-butylphosphino)-1-phenyl-1H-pyrrole. Very particular preference is given to triphenylphosphine, tritolylphosphine, tri-n-butylphosphine, tri-n-octylphosphine, trimethylphosphine and triethylphosphine, and also di(1-adamantyl)-n-butylphosphine, 2-(dicyclohexylphosphino)-1-phenyl-1H-pyrrole and 2-(di-tert-butylphosphino)-1-phenyl-1H-pyrrole.

Particularly suitable polydentate phosphine ligands are bis(diphenylphosphino)methane, 1,2-bis(diphenylphosphino)ethane, 1,2-dimethyl-1,2-bis(diphenylphosphino)ethane, 1,2-bis(dicyclohexylphosphino)ethane, 1,2-bis(diethylphosphino)ethane, 1,3-bis(diphenylphosphino)propane, 1,4-bis(diphenylphosphino)butane, 2,3-bis(diphenylphosphino)butane, 1,3-bis(diphenylphosphino)propane, 1,1,1-tris(diphenylphosphinomethyl)ethane, 1,1′-bis(diphenylphosphanyl)ferrocene and 4,5-bis(diphenylphosphino)-9,9-dimethylxanthene.

Furthermore, mention may preferably be made of nitrogen-heterocyclic carbenes as particularly suitable ligands for the catalyst for the polycondensation or poly-co-condensation described above. In this connection, those ligands which form water-soluble complexes with ruthenium are very preferred. Particular preference is given to 1-butyl-3-methylimidazolin-2-ylidene, 1-ethyl-3-methylimidazolin-2-ylidene, 1-methylimidazolin-2-ylidene and dipropylimidazolin-2-ylidene.

Particularly suitable ligands for the catalyst in the polycondensation or poly-co-condensation described above which may be mentioned are also cyclopentadienyl and its derivatives mono- to pentasubstituted with alkyl, aryl and/or hydroxy, such as, for example, methylcyclopentadienyl, pentamethylcyclopentadienyl, tetraphenylhydroxycyclopentadienyl and pentaphenylcyclopentadienyl. Further particularly suitable ligands are indenyl and its derivatives substituted as described for cyclopentadienyl.

Likewise particularly suitable ligands for the catalyst in polycondensations or poly-co-condensations described above are chloride, hydride and carbonyl.

The transition metal complex catalyst in the polycondensation or poly-co-condensation described above can comprise two or more different or identical ligands described above.

Homogeneous catalysts can be used either directly in their active form or else be produced starting from customary standard complexes such as, for example, Ru(p-cymene)Cl₂]₂, [Ru(benzene)Cl₂]_{y}, [Ru(CO)₂Cl₂]_{y}, where y is in each case in the range from 1 to 1000, [Ru(CO)₃Cl₂]₂, [Ru(COD)(allyl)], RuCl₃.H₂O, [Ru(acetylacetonate)₃], [Ru(DMSO)₄Cl₂], [Ru(Cp)(CO)₂Cl], [Ru(Cp)(CO)₂H], [Ru(Cp)(CO)₂]₂, [Ru(Cp)(CO)₂Cl], [Ru(Cp*)(CO)₂H], [Ru(Cp*)(CO)₂]₂, [Ru(indenyl)(CO)₂Cl], [Ru(indenyl)(CO)₂H], [Ru(indenyl)(CO)₂]₂, ruthenocene, [Ru(COD)Cl₂]₂, [Ru(Cp*)(COD)Cl], [Ru₃(CO)₁₂], [Ru(PPh₃)₄(H)₂], [Ru(PPh₃)₃(Cl)₂], [Ru(PPh₃)₃(CO)(Cl)₂], [Ru(PPh₃)₃(CO)(Cl)(H)], [Ru(PPh₃)₃(CO)(H)₂] and [Ru(Cp)(methylallyl)₂], [Ru(bipyridine)₂Cl₂.2H₂O], [Ru(COD)Cl₂]₂, [Ru(Cp*)(COD)Cl], [Ru₃(CO)₁₂], [Ru(tetraphenylhydroxy-cyclopentadienyl)(CO)₂H], [Ru(PMe₃)₄(H)₂], [Ru(PEt₃)₄(H)₂], [Ru(P(n-Pr)₃)₄(H)₂], [Ru(P(n-Bu)₃)₄(H)₂], [Ru(Pn-Octyl₃)₄(H)₂], [IrCl₃.H₂O], KIrCl₄, K₃IrCl₆, [Ir(COD)Cl]₂, [Ir(cyclooctene)₂Cl]₂, [Ir(ethene)₂Cl]₂, [Ir(Cp)Cl₂]₂, [Ir(Cp*)Cl₂]₂, [Ir(Cp)(CO)₂], [Ir(Cp*)(CO)₂], [Ir(PPh₃)₂(CO)(H)], [Ir(PPh₃)₂(CO)(Cl)], [Ir(PPh₃)₃(Cl)] with the addition of the corresponding ligands, preferably the aforementioned mono- or polydentate phosphine ligands or the aforementioned nitrogen-heterocyclic carbenes, only under the reaction conditions.

For the purposes of the present invention, Cp means cyclopentdienyl and Cp* means pentamethylcyclopentadienyl. COD means cycloocta-1,5-dienyl, Et: ethyl, Me: methyl, Ph: phenyl, n-Pr: n-propyl, n-Bu: n-butyl.

In one embodiment of the present invention, the backbone synthesized according to polycondensations or poly-co-condensations described above have a hydroxyl value in the range of from 1 to 1,000 mg KOH/g, preferably from 2 to 500 mg KOH/g, most preferred from 10 to 300 mg KOH/g. The hydroxyl value can be determined according to DIN 53240.

In one embodiment of the present invention, the backbone of alkoxylate (A) synthesized according to polycondensations or poly-co-condensations described above have a primary amine value in the range of from 1 to 1000 mg KOH/g, preferably from 10 to 500 mg KOH/g, most preferred from 50 to 300 mg KOH/g. The primary amine value can be determined according to ASTM D2074-07.

In one embodiment of the present invention, the backbone of alkoxylate (A) synthesized according to polycondensations or poly-co-condensations described above have a secondary amine value in the range of from 1 to 1000 mg KOH/g, preferably from 10 to 500 mg KOH/g, most preferred from 50 to 300 mg KOH/g. The secondary amine value can be determined according to ASTM D2074-07.

In one embodiment of the present invention, the backbone of alkoxylate (A) synthesized according to polycondensations or poly-co-condensations described above have a tertiary amine value in the range of from 1 to 300 mg KOH/g, preferably from 5 to 200 mg KOH/g, most preferred from 10 to 100 mg KOH/g. The tertiary amine value can be determined according to ASTM D2074-07.

In one embodiment of the present invention, the molar share of tertiary N atoms is determined by ¹⁵N-NMR spectroscopy. In cases that tertiary amine value and result according to ¹⁵N-NMR spectroscopy are inconsistent, the results obtained by ¹⁵N-NMR spectroscopy will be given preference.

In a preferred embodiment of the present invention, the polypropylenimine backbone of alkoxylated polypropylenimine (A) may be obtained by a catalytic polycondensation of propandiamine and, optionally, at least one further diamine.

Examples of propandiamines are propane-1,2-diamine and propane-1,3-diamine and mixtures thereof. Particularly preferred are poly-transaminations of propane-1,3-diamine.

Optionally, up to 40 mol-% of the propandiamine may be replaced by a one or more aliphatic diamine other than propandiamine, in particular up to 30 mol-%.

Examples of further aliphatic diamines are linear, branched or cyclic diamines. Special examples are ethylenediamine, butylenediamine, for example 1,4-butylenediamine or 1,2-butylenediamine, diaminopentane, for example 1,5-diaminopentane or 1,2-diaminopentane, diaminohexane, for example 1,6-diaminohexane or 1,2-diaminohexane or diamino-2-methylpentane, diaminoheptane, for example 1,7-diaminoheptane or 1,2-diaminoheptane, diaminooctane, for example 1,8-diaminooctane or 1,2-diaminooctane, diaminononane, for example 1,9-diaminononane or 1,2-diaminononane, diaminodecane, for example 1,10-diaminodecane or 1,2-diaminodecane, diaminoundecane, for example 1,11-diaminoundecane or 1,2-diaminoundecane, diaminododecane, for example 1,12-diaminododecane or 1,2-diaminododecane, wherein the respective α,ω-diamines are preferred over their 1,2-isomers, 2,2-dimethylpropane-1,3-diamine, 4,7,10-trioxatridecane-1,13-diamine, 4,9-dioxadodecane-1,12-diamine, polyetheramines, and 3-(methylamino)propylamine. Preference is given to 1,2-ethylendiamine and 1,4-butandiamine.

In the context of the present invention, compounds with 2 NH₂-groups and a tertiary amino group, such as, but not limited to N,N-bis(3-aminopropyl)methylamine, are also being considered as diamines.

In a particularly preferred embodiment, the backbone of alkoxylated polypropylenimine (A) may be obtained by a catalytic poly-transamination of propane-1,3-diamine, without any additional diamine other than propane-1,3-diamine.

Catalysts suitable for the polycondensation of propandiamine and optionally at least one further aliphatic diamine are particularly heterogeneous catalysts that contain at least one or more transition metals selected from Fe, Co, Ni, Ru, Rh, Pd, Os, Ir, and Pt, preferably from Co, Ni, Ru, Cu and Pd, and particularly preferably Co, Ni or Cu, as well as mixtures of at least two of the above. The metals above may also be termed catalytically active metals in the context of the present invention.

In one embodiment of the present invention, a catalytically active metal can be doped with a promoter, for example, with at least one metal different from the catalytically active metal selected from Cr, Co, Mn, Mo, Ti, Sn, alkali metals, alkali earth metals, or phosphorus.

It is preferred to employ a Raney-type catalyst that can be obtained by activating an alloy of a catalytically active metal and at least one additional metal, in particular aluminum. Preferred are Raney-Nickel and Raney-Cobalt.

In one embodiment, supported Pd or supported Pt catalysts can be applied. Preferred support materials are carbon, for example as charcoal, as well as Al₂O₃, TiO₂, ZrO₂ and SiO₂.

Particularly preferred are catalysts that can be obtained by reduction of a catalyst precursor. A precursor may comprise a catalytically active component, and optionally at least one additional component selected from promoters and support materials. The so-called catalytically active component is usually a compound of the respective catalytically active metal, for example an oxide or a hydroxide, such as—but not limited to—CoO, CuO, NiO or mixtures from any combinations therefrom.

The poly-transamination of propandiamine and, optionally, further diamine(s) can be carried out in the presence of hydrogen, for example under a hydrogen pressure of from 1 to 400 bar, preferably under a hydrogen pressure in the range of from 1 to 200 bar and even more preferably under a hydrogen pressure in the range of from 1 to 100 bar.

The poly-transamination of propandiamine and, optionally, further diamine(s) can be carried out at a temperature in the range of from 50 to 200° C. Preferably, the temperature is in the range of from 90 to 180° C. and preferably in the range of from 120 to 160° C.

In one embodiment of the present invention, the poly-transamination of propandiamine and, optionally, further diamine(s) can be carried out at a pressure in the range of from 1 to 400 bar, preferably in the range of from 1 to 200 bar and even more preferably in the range of from 1 to 100 bar.

A backbone of alkoxylate (A) will be obtained. In embodiments in which a poly-transamination of diamine(s) has been performed, the respective backbone of alkoxylate (A) does not bear any hydroxyl groups. Therefore, its hydroxyl value is zero mg KOH/g, determined according to DIN 53240. In the context of the present invention, the term that the respective backbone of alkoxylate (A) does not bear any hydroxyl groups refers to the respective backbone before alkoxylation.

In embodiments in which a poly-transamination of propandiamine and, optionally, further diamine(s) has been performed, the respective backbone of alkoxylate (A) can have a primary amine value in the range of from 10 to 1000 mg KOH/g, preferably from 80 to 800 mg KOH/g, most preferred from 100 to 500 mg KOH/g. The primary amine value can be determined according to ASTM D2074-07.

In embodiments in which a poly-transamination of propandiamine and, optionally, further diamine(s) has been performed, the respective backbone of alkoxylate (A) can have a secondary amine value in the range of from 100 to 2000 mg KOH/g, preferably from 200 to 1500 mg KOH/g, most preferred from 300 to 1000 g KOH/g. The secondary amine value can be determined according to ASTM D2074-07.

In embodiments in which a poly-transamination of propandiamine and, optionally, further diamine(s) has been performed, the respective backbone of alkoxylate (A) can have a tertiary amino groups in the range of from zero to 2 mol-%, referring to the total number of N atoms in the respective polypropylenimine. The molar share of tertiary N atoms is determined by ¹⁵N-NMR spectroscopy.

In a preferred embodiment of the present invention the number average molecular weight Mₙ of the backbone of alkoxylate (A) is in the range of from 300 to 4,000 g/mol, preferably from 400 to 2,000 g/mol, determined by size exclusion chromatography.

In a preferred embodiment of the present invention the molar mass distribution M_{w}/Mₙ of backbone of alkoxylate (A) is in the range from 1.2 to 20, preferably from 1.5 to 7.5.

In a preferred embodiment of the present invention, the cationic charge density of a backbone of alkoxylate (A) is in the range from 4 to 22 meq/g of dry matter, preferably in the range from 6 to 18 meq/g dry matter, determined at a pH value in the range of from 3 to 4, by titration.

Alkoxylated polypropylenimine (A) comprises alkoxy side chains. Said alkoxy side chains can be attached to the backbone by alkoxylation. Alkoxy side chains can be attached to the backbone by reacting the respective polypropylenimine with at least one alkylene oxide, for example ethylene oxide, propylene oxide, butylene oxide, pentylene oxide, decenyl oxide, dodecenyl oxide, or mixtures of at least two alkylene oxides of the foregoing. Preference is given to ethylene oxide, 1,2-propylene oxide and mixtures of ethylene oxide and 1,2-propylene oxide. If mixtures of at least two alkylene oxides are applied, they can be reacted random-wise or block-wise.

The reaction of the backbone with alkylene oxide can be performed, e. g., in the presence of a catalyst. Suitable catalysts are, for example, Lewis acids such as such as, for example, AlCl₃ or BF₃ etherate, BF₃, BF₃.H₃PO₄, SbCl₅.2 H₂O and hydrotalcite. Preferred catalysts are selected from strong bases such as potassium hydroxide, sodium hydroxide, potassium methylate (KOCH₃), sodium methylate (NaOCH₃), and potassium tert.-butylate (KOC(CH₃)₃) preferably from potassium hydroxide and sodium hydroxide.

In one embodiment of the present invention, alkoxylated polypropylenimine (A) is selected from those with alkylene oxide units and N atoms in a molar ratio in the range of from 1:1 to 100:1, preferably in the range of from 2:1 to 50:1, the N atoms resulting from alkylenimine units. The alkylenimine units are propylenimine units in their majority, for example at least 60 mol-%, referring to the total of alkylenimine units, preferably at least 70 mol-%.

In one embodiment of the present invention, alkoxylated polypropylenimine (A) is selected from those with alkylene oxide units and N atoms in a molar ratio in the range of from 1:1 to 100:1, preferably in the range of from 2:1 to 50:1, the N atoms resulting from propylenimine units, and no alkylenimine units other than propylenimine units being present.

Alkoxylated polypropylenimine (A) can be present in compositions as such or as a derivative. Suitable derivatives are, for example, obtained by quaternization or by sulfatization (sulphation).

In one embodiment of the present invention, alkoxylated polypropylenimine (A) is quaternized, fully or partially, or sulfatized (sulphated), fully or partially. Preferably, alkoxylated polypropylenimine (A) is quaternized, fully or partially, and sulfatized, fully or partially, to an extent similar as the quaternization. Quaternization can be obtained, for example, by reacting an alkoxylated polypropylenimine (A) with an alkylation agent such as a C₁-C₄-alkyl halide, for example with methyl bromide, ethyl chloride, methyl iodide, n-butyl bromide, isopropyl bromide, or with a di-C₁-C₄-alkyl sulphate, optionally in the presence of a base, especially with dimethyl sulphate or with diethyl sulphate. Suitable bases are, for example, NaOH and KOH.

Combined quaternization and sulfatization can be achieved, e. g., by first reacting an alkoxylated polypropylenimine (A) with a di-C₁-C₄-alkyl sulphate in the presence of a base, then acidifying the reaction mixture obtained from quaternization, for example with a carboxylic acid, such as lactic acid, or with a mineral acid such as phosphoric acid, sulphuric acid or hydrochloric acid. In another embodiment, a quaternized alkoxylated polypropylenimine (A) can be reacted with a sulfatization reagent such as, but not limited to sulphuric acid (preferably 75 to 100% strength, more preferably 85 to 98% strength), oleum, SO₃, chlorosulphuric acid, sulphuryl chloride, amidosulphuric acid and the like. If sulphuryl chloride is selected as sulphatization agent chloride can be removed by aqueous work-up after sulphatization.

In one embodiment of the present invention, alkoxylated polypropylenimines (A) is a component of a laundry care composition that additionally comprises at least one anionic surfactant (B) and at least one builder (C).

Examples of suitable anionic surfactants (B) are alkali metal and ammonium salts of C₈-C₁₂-alkyl sulfates, of C₁₂-C₁₈-fatty alcohol ether sulfates, of C₁₂-C₁₈-fatty alcohol polyether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, anionic surfactants (B) are selected from n-C₁₀-C₁₈-alkylbenzene sulfonic acids and from fatty alcohol polyether sulfates, which, within the context of the present invention, are in particular sulfuric acid half-esters of ethoxylated C₁₂-C₁₈-alkanols (ethoxylation: 1 to 50 mol of ethylene oxide/mol), preferably of n-C₁₂-C₁₈-alkanols.

Examples of builders (C) are complexing agents, hereinafter also referred to as complexing agents (C), ion exchange compounds, and precipitating agents (C). Examples of builders (C) are citrate, phosphates, silicates, carbonates, phosphonates, amino carboxylates and polycarboxylates.

Examples of complexing agents (C) (“sequestrants”) are selected from complexing agents such as, but not limited to citrate, phosphates, phosphonates, silicates, and ethylene amine derivatives selected from ethylene diamine tetraacetate, diethylene pentamine pentaacetate, methylglycine diacetate, and glutamine diacetate. Complexing agents (C) will be described in more details below.

Examples of precipitating agents (C) are sodium carbonate and potassium carbonate.

In one embodiment of the present invention, the use according to the invention comprises the use of alkoxylate (A) together with at least one enzyme (D). Useful enzymes are, for example, one or more lipases, hydrolases, amylases, proteases, cellulases, hemicellulases, phospholipases, esterases, pectinases, lactases and peroxidases, and combinations of at least two of the foregoing types of the foregoing.

The use according to the invention can deal with any type of laundry, and with any type of fibers. Fibers can be of natural or synthetic origin, or they can be mixtures of natural of natural and synthetic fibers. Examples of fibers of natural origin are cotton and wool. Examples for fibers of synthetic origin are polyurethane fibers such as Spandex® or Lycra®, polyester fibers, or polyamide fibers. Fibers may be single fibers or parts of textiles such as knitwear, wovens, or nonwovens.

The use according to the invention can be performed by applying alkoxylate (A) as a liquid, for example as a solution or gel, as a foam or as solid to fibres. It is preferred to use alkoxylate (A) in a washing liquor. Before application, it can be stored in a formulation that may be solid or liquid, liquid being preferred.

Preferably, the use according to the invention can be performed for cleaning, for example for desoiling, degreasing, or the like of laundry. The soil or dirt to be removed can be proteins, grease, fat, oil, sebum, non-polar soils like soot and byproducts of incomplete hydrocarbon combustion, particulate stains such as pigments and clays, or mixtures of at least two of the foregoing. Particularly preferred is the use according to the invention for grease removal (degreasing) and clay soil removal/anti redeposition.

It is preferred to use alkoxylate (A) at a temperature in the range of from 15 to 90° C., preferably in the range of from 20 to 60° C.

The use according to the invention can be performed manually but it is preferred to apply alkoxylate (A) mechanically, for example in a washing machine.

A further aspect of the present invention are detergent compositions, in the context of the present invention also being referred to as compositions according to the invention. Compositions according to the invention can be liquid, gels, or solid compositions, solid embodiments encompassing, for example, powders and tablets. Liquid compositions may be packaged as unit doses.

Compositions according to the invention comprise
(A) at least one alkoxylated polypropylenimine selected from those with a polypropylenimine backbone with a molecular weight Mₙ in the range of from 300 to 4,000 g/mol,
(B) at least one anionic surfactant,
(C) at least one builder, selected from citrate, phosphates, silicates, carbonates, phosphonates, amino carboxylates and polycarboxylates.
   Alkoxylated polypropylenimine (A) and anionic surfactants (B) have been defined above.

Compositions according to the invention may comprise at least one builder (C). In the context of the present invention, no distinction will be made between builders and such components elsewhere called “co-builders”. Examples of builders (C) are complexing agents, hereinafter also referred to as complexing agents (C), ion exchange compounds, and precipitating agents (C). Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylenediaminetetramethylenephosphonate (EDTMP), diethylenetriaminepentamethylenphosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Compositions according to the invention may contain one or more builder selected from materials not being mentioned above. Examples of builders are α-hydroxypropionic acid and oxidized starch.

In one embodiment of the present invention, builder (C) is selected from polycarboxylates. The term “polycarboxylates” includes non-polymeric polycarboxylates such as succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol(meth)acrylate, methoxypolypropylene glycol(meth)acrylate, methoxypolybutylene glycol(meth)acrylate, methoxypoly(propylene oxide-co-ethylene oxide)(meth)acrylate, ethoxypolyethylene glycol(meth)acrylate, ethoxypolypropylene glycol(meth)acrylate, ethoxypolybutylene glycol(meth)acrylate and ethoxypoly(propylene oxide-co-ethylene oxide)(meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxyl)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s) (C), especially in the case of solid formulations. Liquid formulations according to the invention preferably comprise in the range of from 0.1 to 8% by weight of builder (C).

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium.

Examples of useful enzymes (D) are one or more lipases, hydrolases, amylases, proteases, cellulases, hemicellulases, phospholipases, esterases, pectinases, lactases and peroxidases, and combinations of at least two of the foregoing types of the foregoing.

Enzyme (D) can be incorporated at levels sufficient to provide an effective amount for cleaning. The preferred amount is in the range from 0.001% to 5% of active enzyme by weight in the detergent composition according to the invention. Together with enzymes also enzyme stabilizing systems may be used such as for example calcium ions, boric acid, boronic acid, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH, adipic acid and mixtures from at least two of the foregoing, as well as the respective sodium and potassium salts.

Compositions according to the invention may comprise one or more bleaching agent (E) (bleaches).

Preferred bleaches (E) are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylenediamine, tetraacetylglycoluril, tetraacetylhexylenediamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention can comprise one or more builders, for example sodium sulfate.

Formulations according to the invention may comprise at least one additional surfactant, selected from non-ionic surfactants and amphoteric surfactants.

### Non-Ionic Surfactants

Examples of surfactants are in particular nonionic surfactants. Preferred nonionic surfactants are alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides) and so-called amine oxides.

Preferred examples of alkoxylated alcohols and alkoxylated fatty alcohols are, for example, compounds of the general formula (I)

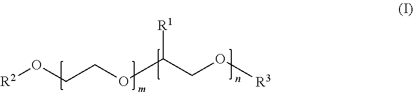

in which the variables are defined as follows:
R¹ is selected from linear C₁-C₁₀-alkyl, preferably ethyl and particularly preferably methyl,
R² is selected from C₈-C₂₂-alkyl, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
   m and n are in the range from zero to 300, where the sum of n and m is at least one. Preferably, m is in the range from 1 to 100 and n is in the range from 0 to 30.

Here, compounds of the general formula (I) may be block copolymers or random copolymers, preference being given to block copolymers.

Other preferred examples of alkoxylated alcohols and alkoxylated fatty alcohols are, for example, compounds of the general formula (II)

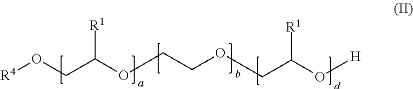

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (II) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides such as lauryl dimethyl amine oxide (“lauramine oxide”) or alkylphenol ethoxylates or alkyl polyglycosides or polyhydroxy fatty acid amides (glucamides) are likewise suitable. An overview of suitable further nonionic surfactants can be found in EP-A 0 851 023 and in DE-A 198 19 187.

Mixtures of two or more different nonionic surfactants may also be present.

Examples of amphoteric surfactants are C₁₂-C₁₈-alkylbetaines and sulfobetaines.

Further optional ingredients may be but are not limited to viscosity modifiers, cationic surfactants, foam boosting or foam reducing agents, perfumes, dyes, optical brighteners, dye transfer inhibiting agents and preservatives.

A further aspect of the present invention is a process for making a detergent composition according to the present invention, hereinafter also being referred to as process according to the invention. In order to perform the process according to the invention, components (A), (B) and (C) as defined above and, optionally, further components are being mixed together in the presence of water. The order of addition of the various ingredients is not critical but it is preferred to add the detergent(s) first and to add the enzyme(s), if desired, as last component. Mixing can be accomplished, for example, by agitating or stirring. Said agitating or stirring can be performed until a clear solution or a homogeneous-looking dispersion has formed.

If solid detergent compositions are desired then the water can be removed, in whole or in part, for example by spray-drying, for example with the help of a spray nozzle.

In the context of the present invention, also a process for manufacture of alkoxylated (A) is being disclosed, hereinafter also being referred to as the synthesis. In one embodiment, the synthesis comprises the following steps:
(a) reacting propandiamine and optionally at least one further aliphatic diamine in the presence of a catalyst under formation of a polypropylenimine that is free of hydroxyl groups,
(b) reacting the polypropylenimine obtained according to step (a) with at least one alkylene oxide.

The above steps are also being referred to as step (a) or step (a) of synthesis and as step (b) or step (b) of the synthesis, respectively.

In a preferred embodiment of the present invention, step (a) of the synthesis may be performed by a polycondensation of propandiamine and, optionally, at least one further diamine in the presence of a catalyst.

Examples of propandiamines are propane-1,2-diamine and propane-1,3-diamine and mixtures thereof. Particularly preferred are poly-condensations of propane-1,3-diamine.

Optionally, up to 40 mol-% of the propandiamine may be replaced by a one or more aliphatic diamine other than propandiamine, in particular up to 30 mol-%.

Examples of further aliphatic diamines are linear, branched aliphatic or cycloaliphatic diamines. Special examples are ethylenediamine, butylenediamine, for example 1,4-butylenediamine or 1,2-butylenediamine, diaminopentane, for example 1,5-diaminopentane or 1,2-diaminopentane, 1,5-diamino-2-methylpentane, diaminohexane, for example 1,6-diaminohexane or 1,2-diaminohexane, diaminoheptane, for example 1,7-diaminoheptane or 1,2-diaminoheptane, diaminooctane, for example 1,8-diaminooctane or 1,2-diaminooctane, diaminononane, for example 1,9-diaminononane or 1,2-diaminononane, diaminodecane, for example 1,10-diaminodecane or 1,2-diaminodecane, diaminoundecane, for example 1,11-diaminoundecane or 1,2-diaminoundecane, diaminododecane, for example 1,12-diaminododecane or 1,2-diaminododecane, wherein the respective α,ω-diamines are preferred over their 1,2-isomers, 2,2-dimethylpropane-1,3-diamine, 4,7,10-trioxatridecane-1,13-diamine, 4,9-dioxadodecane-1,12-diamine, and 3-(methylamino)propylamine. Preference is given to 1,2-ethylendiamine and 1,4-butandiamine.

In the context of the present invention, compounds with 2 NH₂-groups and a tertiary amino group, such as, but not limited to N,N-bis(3-aminopropyl)methylamine, are also being considered as diamines.

In a particularly preferred embodiment, the backbone of alkoxylated (A) may be obtained by a polycondensation of propane-1,3-diamine, without any additional diamine other than propane-1,3-diamine, in the presence of a catalyst.

Catalysts suitable for step (a) of the process according to the invention are particularly heterogeneous catalysts that contain at least one or more transition metals selected from Fe, Co, Ni, Ru, Rh, Pd, Os, Ir, and Pt, preferably from Co, Ni, Ru, Cu and Pd, and particularly preferably Co, Ni or Cu, as well as mixtures of at least two of the above. The metals above may also be termed catalytically active metals in the context of the present invention.

In one embodiment of the present invention, a catalytically active metal can be doped with a promoter, for example, with at least one metal different from the catalytically active metal selected from Cr, Co, Mn, Mo, Ti, Sn, alkali metals, alkali earth metals, or phosphorus.

It is preferred to employ a Raney-type catalyst that can be obtained by activating an alloy of a catalytically active metal and at least one additional metal, in particular aluminum. Preferred are Raney-Nickel and Raney-Cobalt.

In one embodiment of the process according to the invention, supported Pd or supported Pt catalysts can be applied. Preferred support materials are carbon, for example as charcoal, as well as Al₂O₃, TiO₂, ZrO₂ and SiO₂.

Particularly preferred are catalysts that can be obtained by reduction of a catalyst precursor. A precursor may comprise a catalytically active component, and optionally at least one additional component selected from promoters and support materials. The so-called catalytically active component is usually a compound of the respective catalytically active metal, for example an oxide or a hydroxide, such as—but not limited to—CoO, CuO, NiO or mixtures from any combinations therefrom.

Step (a) of the synthesis can be carried out in the presence of hydrogen, for example under a hydrogen pressure of from 1 to 400 bar, preferably under a hydrogen pressure in the range of from 1 to 200 bar and even more preferably under a hydrogen pressure in the range of from 1 to 100 bar.

Step (a) of the synthesis can be carried out at a temperature in the range of from 50 to 200° C. Preferably, the temperature is in the range of from 90 to 180° C. and preferably in the range of from 120 to 160° C.

In one embodiment of the present invention, step (a) of the synthesis can be carried out at a pressure in the range of from 1 to 400 bar, preferably in the range of from 1 to 200 bar and even more preferably in the range of from 1 to 100 bar.

During step (a) of the synthesis, it is preferred to remove the ammonia evolved.

Step (b) of the synthesis comprises reacting the polypropylenimine obtained in step (a) with at least one alkylene oxide, for example ethylene oxide, propylene oxide, butylene oxide, pentylenoxide, decenyl oxide, dodecenyl oxide, or mixtures of at least two alkylene oxides of the foregoing. Preference is given to ethylene oxide, 1,2-propylene oxide and mixtures of ethylene oxide and 1,2-propylene oxide. If mixtures of at least two alkylene oxides are applied, they can be reacted random-wise or block-wise.

Step (b) of the synthesis is carried out in the presence of a catalyst. Suitable catalysts are, for example, selected from strong bases such as potassium hydroxide, sodium hydroxide, sodium or potassium alkoxides such as potassium methylate (KOCH₃), potassium tert-butoxide, sodium ethoxide and sodium methylate (NaOCH₃), preferably from potassium hydroxide and sodium hydroxide. Further examples of catalysts are alkali metal hydrides and alkaline earth metal hydrides such as sodium hydride and calcium hydride, and alkali metal carbonates such as sodium carbonate and potassium carbonate. Preference is given to the alkali metal hydroxides and the alkali metal alkoxides, particular preference being given to potassium hydroxide and sodium hydroxide. Typical use amounts for the base are from 0.05 to 10% by weight, in particular from 0.5 to 2% by weight, based on the total amount of polypropylenimine and alkylene oxide.

In one embodiment of the present invention, step (b) of the synthesis is carried out at temperatures in the range of from 90 to 240° C., preferably from 120 to 180° C., in a closed vessel.

In one embodiment of the present invention, step (b) of the synthesis is carried out at a pressure in the range of from 1 to 10 bar, preferably 1 to 8 bar.

In one embodiment of the present invention, alkylene oxide(s) is/are introduced to polypropylenimine from step (a) and optionally to the catalyst under the vapour pressure of the alkylene oxide or of the respective mixture of alkylene oxides at the selected reaction temperature. Alkylene oxide(s) can be introduced in pure form or, as an alternative, be diluted up to 30 to 60% by volume with an inert gas such as a rare gas or nitrogen. This measure affords additional safety against explosion-like polyaddition of the alkylene oxide.

In case several alkylene oxides are being introduced polyether chains will be formed in which the different alkylene oxide units are distributed virtually randomly. Variations in the distribution of the units along the polyether chain can arise due to differing reaction rates of the alkylene oxides. Variations in the distribution of the units along the polyether chain can be achieved arbitrarily by continuously introducing an alkylene oxide mixture of program-controlled composition as well. In case different alkylene oxides are reacted subsequently, then polyether chains with a block-type distribution of the alkylene oxide units are obtained.

In a preferred embodiment of the present invention, step (b) can consist of two or more sub-steps, of which the first sub-step consists in initially undertaking only an incipient alkoxylation of the polypropylene imine resulting from step (a). In the incipient alkoxylation, the polypropylene imine resulting from step (a) is reacted with a portion of the total amount of alkylene oxide used that corresponds to 1 mole of alkylene oxide per mole of NH moiety. The incipient alkoxylation is generally undertaken in the absence of a catalyst, preferably in an aqueous solution.

In one embodiment of the present invention, the incipient alkoxylation can be performed at a reaction temperature from 70 to 200° C., preferably from 80 to 160° C.

In one embodiment of the present invention, the incipient alkoxylation may be affected at a pressure of up to 10 bar, preferably up to 8 bar.

In a second sub-step and—optionally, in subsequent sub-steps—the further alkoxylation is then effected by subsequent reaction with alkylene oxide. The further alkoxylation is typically undertaken in the presence of a catalyst.

The second sub-step—and the optional subsequent sub-steps—may each be undertaken in bulk, embodiment (i), or in an organic solvent, embodiment (ii). In embodiment (i), water can be removed from the aqueous solution of the incipiently alkoxylated polypropylenimine obtained in the first sub-step. Such water removal can be done by heating to a temperature in the range of from 80 to 150° C. under a reduced pressure in the range of from 0.01 to 0.5 bar and distilling off the water.

In one embodiment of the present invention, the subsequent reaction with alkylene oxide(s) is effected typically at a reaction temperature in the range of from 70 to 200° C. and preferably from 100 to 180° C.

In one embodiment of the present invention, the subsequent reaction with alkylene oxide(s) is effected typically at a pressure of up to 10 bar and in particular up to 8 bar.

In one embodiment of the present invention, the reaction time of the subsequent reaction with alkylene oxide(s) is generally in the range of from 0.5 to 12 hours.

Examples of suitable organic solvents for embodiment (ii) are nonpolar and polar aprotic organic solvents. Examples of particularly suitable nonpolar aprotic solvents include aliphatic and aromatic hydrocarbons such as hexane, cyclohexane, toluene and xylene. Examples of particularly suitable polar aprotic solvents are ethers, in particular cyclic ethers such as tetrahydrofuran and 1,4-dioxane, furthermore N,N-dialkylamides such as dimethylformamide and dimethylacetamide, and N-alkyllactams such as N-methylpyrrolidone. It is as well possible to use mixtures of at least two of the above organic solvents. Preferred organic solvents are xylene and toluene.

In embodiment (ii), the solution obtained in the first step, before or after addition of catalyst and solvent, is dewatered, said water removal advantageously being done by removing the water at a temperature in the range of from 120 to 180° C., preferably supported by a stream of nitrogen. The subsequent reaction with the alkylene oxide may be effected as in embodiment (i). In embodiment (i), the graft copolymer according to the invention is obtained directly in substance and may be dissolved in water, if desired. In embodiment (ii), organic solvent is typically removed and replaced by water. The graft copolymers according to the invention may alternatively be isolated in bulk.

Having performed step (b) of the synthesis, alkoxylate (A) is obtained.

The synthesis may comprise or more work-up steps such as purifying alkoxylate (A).

In another embodiment, the process according to the invention comprises the following steps:
(a′) providing a polypropylenimine with a linear polypropylenimine backbone that is free of hydroxyl groups,
(b′) reacting the polypropylenimine according to step (a′) with at least one alkylene oxide.

Polypropylenimines with a linear polypropylenimine backbone that is free of hydroxyl groups have been described above.

Step (b′) of the process according to the invention can be performed analogously to step (b) of the synthesis.

Alkoxylated polypropylenimines (A) are particularly useful as ingredient for compositions according to the invention.

If desired, it is possible to quaternize alkoxylates (A) or to sulfatize them. In particular, it is possible to quaternize and sulfatize them.

Quaternization can be accomplished, for example, by reacting an alkoxylate (A) with an alkylation agent such as a C₁-C₄-alkyl halide, for example with methyl bromide, ethyl chloride, methyl iodide, n-butyl bromide, isopropyl bromide, or with a di-C₁-C₄-alkyl sulphate, optionally in the presence of a base, especially with dimethyl sulphate or with diethyl sulphate. Suitable bases are, for example, NaOH and KOH. The temperature for quaternization may be selected in the range of from 50 to 100° C., preferably in the range of from 60 to 80° C. In most cases, the alkylation reagent reacts quantitatively, but an access can be applied if complete quaternization is desired.

Combined quaternization and sulfatization can be achieved, e. g., by first reacting an alkoxylated polypropylenimine (A) with a di-C₁-C₄-alkyl sulphate in the presence of a base, then acidifying the reaction mixture obtained from quaternization, for example with a carboxylic acid, such as lactic acid, or with a mineral acid such as phosphoric acid, sulphuric acid or hydrochloric acid. In another embodiment, a quaternized alkoxylated polypropylenimine (A) can be reacted with a sulfatization reagent such as, but not limited to sulphuric acid (preferably 75 to 100% strength, more preferably 85 to 98% strength), oleum, SO₃, chlorosulphuric acid, sulphuryl chloride, amidosulphuric acid and the like. If sulphuryl chloride is selected as sulphatization agent chloride can be removed by aqueous work-up after sulphatization.

The sulphatization agent is preferably used in equimolar amounts or in excess, e. g. 1 to 1.5 moles per mol of OH-group of graft copolymer according to the invention, quaternized or not. Suitable temperatures for sulfatization are in the range of from zero to 100° C., preferably 5 to 50° C.

The present invention is further illustrated by the following working examples.

General remarks: percentages are % by weight, unless expressly noted otherwise.

The amine values were determined according to ASTM D2074-07.

Test principles of the clean plate test: Ch. Nitsch et al. SÖFW Journal, 128, p. 23 ff. 2002.

EO: ethylene oxide unit, PO: propylene oxide unit

The amine value was determined according to DIN 53176.

The charge density of alkoxylated polypropylenimines (A) was always determined as follows (see also: Horn, Prog. Colloid & Polym. Sci. 1978, 65, 251):

1 g of the alkoxylated polypropylenimine (A) in question was dissolved in 100 ml of demineralized water. A buffer solution and aqueous HCl were used to establish a pH of 4.0, determined potentiometrically. Three ml of an aqueous solution of toluidine blue (50 mg/l of water) were added, and N/400-KPVS (potassium polyvinyl sulfate) solution (Wako) with a concentration of 0.0004 meq/ml was titrated until the color changed from blue to pink. The charge density was calculated as follows:

LA=0.4·KV
LA: Charge density of the modified polypropylenimine (A) in question, meq/g (milliequivalent/g)
KV: Consumption of the N/400-KPVS solution [ml]

### I. Synthesis of Alkoxylated Polypropylenimines (A)

### I.1 Step (a): Synthesis of Linear Polypropylenimines

### I.1.1 Synthesis of Linear Polypropylenimine L-PPI.1

A 300 ml steel vessel connected to a tubular reactor with an inner diameter of 27 mm was charged with 200 ml 1,3-propylene diamine (“1,3-PDA”). From there, the 1,3-PDA was pumped continuously from the bottom of the vessel together with 50 NI/h of a stream of hydrogen over a fixed-bed Ni/Co catalyst supported on ZrO₂ tablets (3.3 cm) that were located in the tubular reactor. The reaction temperature was 160° C. On top of the tubular reactor, the gas was separated from the liquid phase and the liquid led back into the steel-vessel. The reaction was continued for 2 hours. L-PPI.1 was obtained. Its properties are summarized in Table 1.

### I.1.2 Synthesis of Linear Polypropylenimine L-PPI.2

The reaction according to I.1.1 was repeated, but the reaction time was 150 minutes. L-PPI.2 was obtained.

### I.1.3 Synthesis of Linear Polypropylenimine L-PPI.3

The reaction according to I.1.1 was repeated, but the reaction time was 90 minutes. L-PPI.3 was obtained.

### I.1.4 Synthesis of Linear Polypropylenimine L-PPI.4

In a tubular reactor with an inner diameter of 27 mm, 1,3-PDA was continuously led, together with 10 NI/h hydrogen gas, over a fixed bed catalyst consisting of Co as the active metal. The pressure was 50 bar, the temperature 170° C. 1,3-PDA was fed into the reactor with 0.8 kg/L_{cat}·h. A crude product was obtained. After distilling off the unreacted 1,3-PDA, the dimer and trimer of 1,3-PDA from the crude product, L-PPI.4 was obtained as a colourless liquid. Its properties are summarized in Table 1.

### I.1.5 Synthesis of Linear Polypropylenimine L-PPI.5

In a tubular reactor with an inner diameter of 27 mm, 1,3-PDA was continuously led, together with 10 NI/h hydrogen gas, over a fixed bed catalyst consisting of Co as the active metal. The pressure was 50 bar, the temperature 160° C. 1,3-PDA was fed into the reactor with 0.8 kg/L_{cat}·h. A crude product was obtained. After distilling off the unreacted 1,3-PDA, the dimer and trimer of 1,3-PDA from the crude product, L-PPI.4 was obtained as a colourless liquid. Its properties are summarized in Table 1.

### I.1.6 Synthesis of Linear Polypropylenimine L-PPI.6

In a tubular reactor with an inner diameter of 27 mm, 1,3-PDA was continuously led, together with 10 NI/h hydrogen gas, over a fixed bed catalyst consisting of Co as the active metal. The pressure was at 50 bar, the temperature at 160° C. 1,3-PDA was fed into the reactor with 0.6 kg/L_{cat}·h. The crude product so obtained showed 7% of remaining 1,3-PDA based on factorized GC-area %. After distilling off the unreacted 1,3-PDA, the dimer and trimer of 1,3-PDA from the crude product, L-PPI.6 was obtained as a colourless liquid. Mₙ of 302 g/mol, M_{w} of 533 g/mol and a M_{W}/Mₙ of 1.8.

TABLE 1
Linear polypropylene imines and their properties

| No. | PAV | SAV | PAV/SAV | Mₙ [g/mol] | M_{w}/Mₙ |
|---|---|---|---|---|---|
| L-PPI.1 | 129 | 923 | 1:7.15 | 872 | 3.4 |
| L-PPI.2 | 228 | 826 | 1:3.6 | 474 | 3.4 |
| L-PPI.3 | 228 | 482 | 1:2.1 | 300 | 2.5 |
| L-PPI.4 | 203 | 816 | 1:4.0 | 525 | 1.6 |
| L-PPI.5 | 269 | 786 | 1:2.9 | 409 | 2.3 |
| L-PPI.6 | 206 | 841 | 1:4.1 | 302 | 1.8 |

### Primary and Secondary Amine Values in Mg KOH/g.

NI: norm liter
PAV: primary amine value
SAV: secondary amine value.

### I.2 Step (b): Alkoxylation of Linear Polypropylenimines

I.2.1 Alkoxylation with Molar Ratio EO/NH of 1:1

A 2-litre autoclave was charged with 286.3 g of L-PPI.1 (tertiary amine value: 22.1 mg KOH/g) and 14.3 g water. The autoclave was purged three times with nitrogen and then heated to 110° C. An amount of 265.2 g ethylene oxide was added within two hours. To complete the reaction, the reaction mixture was stirred at 110° C. for 3 hours. Water and volatile compounds, if present, were removed under reduced pressure (10 mbar) at 90° C. Graft copolymer according to the invention GC.1 was obtained as highly viscous yellow oil (522 g).

I.2.2 Alkoxylation with Molar Ratio EO/NH of 10:1

A 2-litre autoclave was charged with 76.9 g of GC.1 and 1.6 g KOH (pellets, 50% by weight KOH, rest water). The autoclave was heated under reduced pressure (10 mbar) to 120° C. and stirred for two hours to remove the water. Then, the autoclave was purged three times with nitrogen and then heated to 140° C. under a pressure of 1 bar. An amount of 332.8 g ethylene oxide was added within two hours. To complete the reaction, the reaction mixture was stirred at 140° C. for 3 hours. Water and volatile compounds, if present, were removed under reduced pressure (10 mbar) at 90° C. Graft copolymer according to the invention GC.2 was obtained as slightly yellow waxy solid (399.5 g).

I.2.3 Alkoxylation with Molar Ratio EO/NH of 20:1

A 2-litre autoclave was charged with 64.0 g of GC.1 and 2.6 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under a pressure of 1 bar. An amount of 584.7 g ethylene oxide was added within four hours. To complete the reaction, the reaction mixture was stirred at 140° C. for three hours. Water and volatile compounds, if present, were removed under reduced pressure (10 mbar) at 90° C. Graft copolymer according to the invention GC.3 was obtained as slightly yellow waxy solid (630.6 g). Amine value: 57.2 mg KOH/g.

I.2.4 Alkoxylation with Molar Ratio EO/PO/NH of 10:7:1

A 2-litre autoclave was charged with 225.6 g of GC.2 and 0.8 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under a pressure of 1 bar. An amount of 187.9 g propylene oxide was added within two hours. To complete the reaction, the reaction mixture was stirred at 140° C. for three hours. Water and volatile compounds, if present, were removed under reduced pressure (10 mbar) at 90° C. Graft copolymer according to the invention GC.4 was obtained as slightly yellow waxy solid (405 g). Amine value: 58.3 mg KOH/g.

I.2.5 Alkoxylation with Molar Ratio EO/PO/NH of 24:16:1

A 2-litre autoclave was charged with 242.8 g of GC.3 and 1.1 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 46.1 g ethylene oxide was added and allowed to react for 3 hours. Then, an amount of 242.9 g propylene oxide was added within two hours. To complete the reaction, the reaction mixture was stirred at 140° C. for three hours. Water and volatile compounds, if present, were removed under reduced pressure (10 mbar) at 90° C. Graft copolymer according to the invention GC.5 was obtained as light brown solid (506 g). Amine value: 28.6 mg KOH/g.

I.2.6 Alkoxylation with Molar Ratio BuO/NH of 1:1

A 2-litre autoclave was charged with 193.7 g of L-PPI.1 and 9.7 g water. The autoclave was purged three times with nitrogen and then heated to 110° C. An amount of 293.6 g butylene-1,2-oxide was added within two hours. To complete the reaction, the reaction mixture was stirred at 110° C. for 3 hours. Water and volatile compounds, if present, were removed in vacuo (10 mbar) at 90° C. Graft copolymer according to the invention GC.6 was obtained as highly viscous yellow oil (460 g).

I.2.7 Alkoxylation with Molar Ratio BuO/NH of 3:1

A 2-litre autoclave was charged with 232.4 g of GC.6 and 2.0 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 280 g butylene-1,2-oxide was added within two hours. To complete the reaction, the reaction mixture was stirred at 140° C. for three hours. Water and volatile compounds, if present, were removed under reduced pressure (10 mbar) at 90° C. Graft copolymer according to the invention GC.7 was obtained as light brown solid (475.1 g). Amine value: 200.8 mg KOH/g.

I.2.8 Alkoxylation with Molar Ratio PO/NH of 1:1

A 2-litre autoclave was charged with 204.4 g of L-PPI.1 and 10.2 g water. The autoclave was purged three times with nitrogen and then heated to 110° C. An amount of 249.6 g propyleneoxide was added within two hours. To complete the reaction, the reaction mixture was stirred at 110° C. for 3 hours. Water and volatile compounds, if present, were removed in vacuo (10 mbar) at 90° C. Graft copolymer according to the invention GC.8 was obtained as highly viscous yellow oil (453 g).

I.2.9 Alkoxylation with Molar Ratio PO/NH of 16:1

A 2-litre autoclave was charged with 73.8 g of GC.8 and 2.7 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 608.6 g propylene oxide was added within two hours. To complete the reaction, the reaction mixture was stirred at 140° C. for five hours. Water and volatile compounds, if present, were removed under reduced pressure (10 mbar) at 90° C. Graft copolymer according to the invention GC.9 was obtained as yellow viscous oil (660.4 g). Amine value: 54.4 mg KOH/g.

1.2.10 Alkoxylation with Molar Ratio EO/PO/NH of 24:16:1

A 2-litre autoclave was charged with 281.9 g of GC.9 and 1.2 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 305.2 g ethylene oxide was added within two hours. To complete the reaction, the reaction mixture was stirred at 140° C. for three hours. Water and volatile compounds, if present, were removed under reduced pressure (10 mbar) at 90° C. Graft copolymer according to the invention GC.10 was obtained as yellow viscous oil (547.4 g). Amine value: 28.1 mg KOH/g.

1.2.11 Alkoxlation with Molar Ratio EO/NH of 30:1

A 2-litre autoclave was charged with 424.0 g of GC.3 and 1.0 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 201.1 g of ethylene oxide was added within two hours. To complete the reaction, the reaction mixture was stirred at 140° C. for three hours. Water and volatile compounds, if present, were removed under reduced pressure (10 mbar) at 90° C. Graft copolymer according to the invention GC.11 was obtained as light brown viscous oil (603 g). Amine value: 39.3 mg KOH/g.

1.2.12 Alkoxlation with Molar Ratio EO/NH of 40:1

A 2-litre autoclave was charged with 210.0 g of GC.11 and 0.6 g KOH (pellets, 50% by weight KOH, rest water). The autoclave was heated under reduced pressure (10 mbar) to 120° C. and stirred for two hours to remove water. Then, the autoclave was purged three times with nitrogen and then heated to 140° C. under pressure of 1 bar. An amount of 67.6 g of ethylene oxide was added within 30 minutes. To complete the reaction, the reaction mixture was stirred at 140° C. for three hours. Water and volatile compounds, if present, were removed under reduced pressure (10 mbar) at 90° C. Graft copolymer according to the invention GC.12 was obtained as light brown solid (275 g). Amine value: 30.9 mg KOH/g.

I.2.13 Alkoxylation with Molar Ratio EO/NH of 1:1

A 2-litre autoclave was charged with 190.9 g of L-PPI.2 and 9.5 g water. The autoclave was purged three times with nitrogen and then heated to 110° C. An amount of 191.8 g ethylene oxide was added within two hours. To complete the reaction, the reaction mixture was stirred at 110° C. for 3 hours. Water and volatile compounds, if present, were removed in vacuo (10 mbar) at 90° C. Graft copolymer according to the invention GC.13 was obtained as highly viscous yellow oil (340 g).

1.2.14 Alkoxylation with Molar Ratio EO/NH of 20:1

A 2-litre autoclave was charged with 60.0 g of GC.13 and 1.3 g KOC(CH₃)₃. The autoclave was purged three times with nitrogen and then heated to 140° C. under pressure of 1 bar. An amount of 571.3 g of ethylene oxide was added within 3 hours. To complete the reaction, the reaction mixture was stirred at 140° C. for three hours. Water and volatile compounds, if present, were removed under reduced pressure (10 mbar) at 90° C. Graft copolymer according to the invention GC.14 was obtained as light brown solid (624.4 g). Surface tension (1 g/I, 25° C.): 60.3 mN/m, determined according to EN 14370.

### 1.2.15 Quaternization of an Alkoxylated Polypropylenimine

In a 250 ml reaction vessel with a nitrogen inlet, a quantity of 160 g GC.3 was heated to 70° C. under a constant stream of nitrogen. 20.56 dimethyl sulphate were added dropwisely, the temperature being maintained at 70 to 75° C. After the addition of the dimethyl sulfate had been completed the reaction mixture so obtained was stirred for two hours at 70° C. under nitrogen and then cooled to room temperature. Then, the pH value (measured 10% in water) was adjusted to 9.4 with 3.2 g sodium hydroxide (50% in water). 178 g graft copolymer according to the invention GC.15 were obtained as a brown solid (amine value: 0.0 mg KOH/g). The degree of quaternization was 100%.

### 1.2.16 Sulfatization of a Quaternized Alkoxylated Polypropylenimine

1.6 g concentrated sulphuric acid (96%) were added to 70.0 g of GC.15 at 60° C. under nitrogen atmosphere. The temperature was raised to 90° C. and the mixture was set under vacuum (15 mbar) for 3 hours. After cooling to 60° C. the pH was adjusted with 1.5 g sodium hydroxide (50% solution in water) to 9.4. An amount of 65 g graft copolymer according to the invention GC.16 was obtained as a brown solid.

### II. Manufacture and Tests of Reference Compositions, Compositions According to the Invention and of Comparative Compositions

### II.1 Manufacture of Reference Compositions

TABLE 1
Detergent composition 1:

| Ingredient | g |
|---|---|
| n-C₁₀-C₁₃-alkylbenzene sulfonic acid | 10.4 |
| coconut C₁₂-C₁₈ fatty acid | 2.5 |
| potassium hydroxide | 3.4 |
| C₁₃C₁₅ oxo alcohol ethoxylate (7 EO) | 5.7 |
| 1,2 propyleneglycol | 6 |
| ethanol | 2 |
| Additional KOH | to pH 9 |
| water | balance to 100 g |

The above ingredients were mixed at ambient temperature.

### II.2 Tests

II.2.1 Clay Soil Removal Tests with GC.3

The following washing experiments with clay soil removal were carried out in a launder-o-meter (manufactured by SDL Atlas).

Commercial fabric standards wfk10A (standard cotton), wfk12A (cotton terry cloth) and wfk 80A (cotton knit) were used in a total amount of 16 g of fabric per 250 ml of washing liquor. The washing liquor contained 1500 ppm of detergent composition 1 and 30 ppm of ethoxylated polypropylenimine GC.3. Water hardness was adjusted to 0.92 mmol/l CaCl₂, 0.23 mmol/l MgCl₂ and 1.84 mmol/l NaHCO₃. The fabrics standard were washed together with 2.5 g soil composition 1 and 20 metal balls at 25° C. for 30 min. After the wash the fabrics were rinsed with water and spin-dried.

The washing cycle was carried out three times and the whiteness index of the fabrics was measured after the first and after the last cycle. Values were compared to fabrics treated under the same conditions as described above but without the addition of ethoxylated polypropylenimine GC.3. Higher values of whiteness index mean a “whiter” fabric and therefore a better clay soil removal/anti redeposition effect.

Soil composition 1:75% deionized water, 20% wfk clay, 5% of a 3:1 mixture of peanut oil and mineral oil

TABLE 2
Whiteness indexes after the first washing cycle

| | wfk 10A | wfk 12A | wfk 80A |
|---|---|---|---|
| Detergent composition 1 | 50.5 | 56.8 | 44.8 |
| Detergent composition 1 together | 55.1 | 68.5 | 54.2 |
| with GC.3 | | | |

TABLE 3
Whiteness indexes after the third washing cycle

| | wfk 10A | wfk 12A | wfk 80A |
|---|---|---|---|
| Detergent composition 1 | 35.9 | 31.3 | 22.9 |
| Detergent composition 1 together | 43.1 | 54.1 | 41.8 |
| with GC.3 | | | |

II.2.2 Soil Removal Tests with GC.5

To evaluate the efficiency of GC.5 as an additive for soil removal the following washing experiments were carried out in a launder-o-meter (manufactured by SDL Atlas). Commercially available soiled fabric standards wfk10D (cotton standard, soil: pigment/sebum) and wfk20D (polyester/cotton 65/35, soil: pigment/sebum) were cut to pieces 4×4 cm in size and sewn onto white cotton fabric swatches. Three soiled fabric standards for each stain type were put together in a launder-o-meter vessel together with other white cotton fabrics, 20 metal balls and with one of the wash liquors detailed in Table 4. Washing experiments were carried out according to the parameters listed in Table 5. After the washing each fabric was dried.

TABLE 4
Composition of wash liquors

| | Concentration | Concentration |
|---|---|---|
| | in wash | in wash |
| Ingredient | liquor 1 | liquor 2 |
| n-C₁₀-C₁₃-alkylbenzene sulfonic | 200 ppm | 200 ppm |
| acid sodium salt | | |
| n-C₁₂-C₁₄ alkyl (OCH₂CH₂)₂—OSO₃Na | 100 ppm | 100 ppm |
| citric acid sodium salt (tri-sodium | 50 ppm | 50 ppm |
| citrate-di- hydrate) | | |
| sodium carbonate | 100 ppm | 100 ppm |
| GC.5 [ppm] | 0 | 25 |
| Lipex 100L (lipase) | 0.05 | 0.05 |
| CaCl₂/MgCl₂, molar ratio 3:1 | 1.0 mmol/l of | 1.0 mmol/l of |
| | Ca²⁺/Mg²⁺ | Ca²⁺/Mg²⁺ |
| water | balance | balance |

TABLE 6
Washing conditions

| | |
|---|---|
| Wash temperature [° C.] | 23.5 |
| Wash time [min] | 30 |
| Total wash liquor [g] | 250 |
| Fabric to wash liquor ratio | 1:17 |

The fabric standards WFK10D and WFK20D as well as fabric standards wfk10A, wfk12A and wfk 80A can be obtained from: wfk Testgewebe GmbH.

Standard colorimetric measurement was used to obtain L*, a* and b* values before and after the washing. From L*, a* and b* values the stain level was calculated. Stain removal from the swatches was calculated as follows:

Stain Removal (SRI)=(ΔEᵢₙᵢₜᵢₐₗ−ΔE_{washed})

ΔEᵢₙᵢₜᵢₐₗ=Stain level before washing

ΔE_{washed}=Stain level after washing

Higher values of soil removal delta mean higher degree of cleaning, i.e. better stain removal. Results from experiments with and without GC.5 were compared.

TABLE 6
Stain removal in SRI

| Soiled fabric | Wash liquor 1 (without GC.5) | Wash liquor 2 (with GC.5) |
|---|---|---|
| WFK10D | 45.5 | 51.1 |
| WFK20D | 43.7 | 54.3 |

From this it can be concluded that GC.5 is an efficient additive for soil cleaning.

II.2.3 Soil Removal Tests with GC.4

To evaluate the efficiency of GC.4. in comparison to an alkoxylated polyethyleneimine, PEI 600 EO/PO/NH of 10:7:1, as additives for soil cleaning the following washing experiments were carried out in a launder-o-meter (manufactured by SDL Atlas).

Commercial soiled fabric standards WFK 10GM (cotton, soil: used motor oil) were cut to pieces 4×4 cm in size and sewn on to white cotton fabric swatches. Three such soiled fabric standards for every stain type were put together in a launder-o-meter vessel together with other white cotton fabrics, 20 metal balls and with one of the wash liquors detailed in Table 7. Washing experiments were carried out according to the parameters listed in Table 8. After the washing each fabric was dried.

TABLE 7
Composition of wash liquors

| | Concentration in | Concentration in | Concentration in |
|---|---|---|---|
| Ingredient | wash liquor 1 | wash liquor 2 | wash liquor 3 |
| n-C₁₀-C₁₃-alkylbenzene sulfonic acid sodium | 200 ppm | 200 ppm | 200 ppm |
| salt | | | |
| n-C₁₂-C₁₄ alkyl (OCH₂CH₂)₂—OSO₃Na | 100 ppm | 100 ppm | 100 ppm |
| citric acid sodium salt (tri-sodium citrate- | 50 ppm | 50 ppm | 50 ppm |
| dihydrate) | | | |
| sodium carbonate | 100 ppm | 100 ppm | 100 ppm |
| PEI EO/PO/NH of 10:7:1 [ppm] | 0 | 25 | 0 |
| GC.4 [ppm] | 0 | 0 | 25 |
| Lipex 100L (lipase) | 0.05 | 0.05 | 0.05 |
| CaCl₂/MgCl₂, molar ratio 3:1 | 1.0 mmol/l of | 1.0 mmol/l of | 1.0 mmol/l of |
| | Ca²⁺/Mg²⁺ | Ca²⁺/Mg²⁺ | Ca²⁺/Mg²⁺ |
| water | balance | balance | balance |

TABLE 8
Washing conditions

| | |
|---|---|
| Wash temperature [° C.] | 25 |
| Wash time [min] | 30 |
| Total wash liquor [g] | 250 |
| Fabric to wash liquor ratio | 1:17 |

The commercial soiled fabric standards WFK 10GM can be obtained from: wfk Testgewebe GmbH.

Higher values of soil removal delta mean higher degree of cleaning, i.e. better stain removal.

Six experiments each were carried out for wash liquor 2 and wash liquor 3. Given below are the averaged results:

TABLE 9
Stain removal in SRI

| | Wash | Wash | Wash | Difference wash liquor 2 vs. |
|---|---|---|---|---|
| Soiled fabric | liquor 1 | liquor 2 | liquor 3 | wash liquor 3 |
| WFK 10GM | 16.2 | 18.7 | 22.1 | significant |

1. A method for laundry care, the method comprising:
introducing at least one alkoxylated polypropylenimine (A) which comprises a polypropylenimine backbone and has a molecular weight Mₙ ranging from 300 to 4,000 g/mol into the laundry.

2. The method according to claim 1, wherein the alkoxylated polypropylenimine (A) comprises alkylene oxide units and N atoms in a molar ratio of from 1:1 to 100:1.

3. The method according to claim 1, wherein the alkoxylated polypropylenimine (A) is an alkoxylated polypropylenimine comprising a linear polypropylenimine backbone.

4. The method according to claim 1, wherein the alkoxylated polypropylenimine (A) is an alkoxylated polypropylenimine comprising a linear polypropylenimine backbone that bears no hydroxyl groups.

5. The method according to claim 1, wherein at least one anionic surfactant (B) and at least one builder (C) are introduced in addition to the alkoxylated polypropylenimine (A).

6. A detergent composition, comprising
(A) an alkoxylated polypropylenimine which comprises a polypropylenimine backbone and has a molecular weight Mₙ ranging from 300 to 4,000 g/mol,
(B) a surfactant, and
(C) at least one builder selected from the group consisting of a citrate, a phosphate, a silicate, a carbonate, a phosphonate, an amino carboxylate, and a polycarboxylate.

7. The detergent composition according to claim 6, wherein the alkoxylated polypropylenimine (A) comprises alkylene oxide units and N atoms in a molar ratio of from 1:1 to 100:1.

8. The detergent composition according to claim 6, wherein the alkoxylated polypropylenimine (A) is an alkoxylated polypropylenimine comprising a linear polypropylenimine backbone.

9. The detergent composition according to claim 6, wherein the alkoxylated polypropylenimine (A) is an alkoxylated polypropylenimine comprising a linear polypropylenimine backbone that bears no hydroxyl groups.

10. The detergent composition according to claim 6, wherein the surfactant (B) is at least one selected from the group consisting of an anionic surfactant, an amphoteric surfactant, and an amine oxide surfactant.

11. The detergent composition according to claim 6, which comprises, based on a total weight of the detergent composition:
(A) a total of from 0.1 to 10.0% by weight of the alkoxylated polypropylenimine,
(B) a total of from 0.5 to 50.0% by weight of the surfactant,
(C) a total of from 0.1 to 70% by weight of the builder.

12. A process for making the detergent composition according to claim 6, the process comprising:
mixing components (A), (B) and (C) and, optionally, further components in the presence of water.

13. The process according to claim 12, further comprising:
subsequently removing water by spray drying.
